(19) United States
(12) Patent Application Publication
(10) Pub. No.: US 2006/0141929 A1
(43) Pub. Date: Jun. 29, 2006

(54) Cellular communication system

(76) Inventors: Douglas Gene Lockie, Los Gatos, CA (US); Mark Alan Sturza, Encino, CA (US)

Correspondence Address: Thomas N. Giaccherini, Post Office Box 1146, Carmel Valley, CA, 93924, US

(21) Appl. No.: 11/024,226

(22) Filed: Dec. 28, 2004

(51) Int. Cl. H04B 7/15

(52) U.S. Cl. 455/11.1

(57) ABSTRACT

Methods and apparatus for improving the performance of a conventional cellular telephone system. In a conventional system, a base station (12) located in a cell (10) both sends and receives signals to and from handheld phones (14). In one embodiment, the present invention employs a relay transceiver (18) located in the cell (10) to relay signals (20) from handheld phones (14) to the a base station (12). The handheld (14) still receives signals (16) directly from the base station (12), but the return signal (22) back to the base station (12) is accomplished through the relay transceiver (18).

### FIELD OF THE INVENTION

The present invention pertains to methods and apparatus for an enhanced cellular communication system. More particularly, one preferred embodiment of the invention employs specially adapted one-way transceivers located around a base station to receive signals from terminals, and to relay the terminal signals to the base station.

### BACKGROUND OF THE INVENTION

By the year 2007, the number of cellular telephone users worldwide is projected to exceed two billion. Although cellular phones have been in widespread use for over two decades, cell phone users are still plagued by poor voice quality and premature disconnections or “dropped calls.” Most of these unwanted disconnections are caused by the weakness of signals transmitted from handheld phones back to the base station that serves each cell. When the strength of this signal falls below a minimum threshhold, the call fails.

One of the most important limitations in a conventional cellular communications system is the return link from a terminal such as a handheld battery operated device. The base station transmitter can easily generate high levels of transmit power, since it includes a high power or “high gain” transmit antenna. The base station receive antenna is a relatively powerful, high gain antenna. The antennas at the base station are powerful because antenna gain is directly proportional to the size of an antenna, and the base station installations can accommodate large sized antennas.

The small handheld terminal antenna, however, is low gain. The power of a handheld phone is also constrained by limited battery power, and by efforts to minimize human exposure to strong radio emissions. The net effect is the handheld terminal transmits a low “EIRP” or effective isotropic radiated power. This relatively low EIRP is the cause of poor performance of most conventional cellular telephone systems. As a consequence, in many cellular calls, the user of the handheld terminal can hear the caller at the other end of call reasonably well, but the voice quality received by the other caller from the cellular phone user is generally diminished.

No current commercially-available device or system provides an inexpensive means of improving the quality of cellular calls and reducing the number of drop-outs. The development of such a system would constitute a major technological advance, and would satisfy long felt needs and aspirations in the telecommunications and cellular telephone industries.

### SUMMARY OF THE INVENTION

The present invention enhances the performance of a conventional cellular telephone system. In a conventional system, a base station located in a cell both sends and receives signals to and from handheld phones.

In one embodiment, the present invention employs a relay transceiver located in the cell to relay signals from handheld phones to the a base station. The handheld still receives signals directly from the base station, but the return signal back to the base station is accomplished through the relay transceiver.

The present invention solves the problem of a poor quality communications in conventional cellular telephone systems caused by handheld terminals which are limited by low effective isotropic radiated power or “EIRP.” In one embodiment, this solution is accomplished by assisting the signal emitted from the handheld terminals. This assistance is provided by placing one or more relay transceivers in a cell with a base station. The signals from the handheld terminals are received by these relay transceivers, and then returned to the base station, which compensates for the low EIRP of the terminals.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is a schematic diagram showing one embodiment of the invention, in which a signal from a terminal in a cell is returned to a base station via a relay transceiver.

FIG. 2 is another schematic diagram that illustrates an alternative embodiment of the invention, in which a signal from a terminal in an inner cell is returned directly to a base station without employing a relay transceiver.

FIG. 3 offers yet another schematic diagram that illustrates an alternative embodiment of the invention, in which a signal from a terminal outside an inner cell is returned to a base station via a relay transceiver.

FIG. 4 provides another schematic view of the present invention, portraying a transceiver relay that is generally located at the periphery of a cell.

FIG. 5 supplies a view of a vehicle as it passes through a set of multiple cells.

FIG. 6 illustrates the operation of relay transceivers which are located at the periphery of a cell.

FIG. 7 offers a plan view of antenna footprints for a base station and receive nodes.

FIGS. 8 and 9 furnish schematic depictions of footprints.

FIG. 10 depicts signal losses over distances from a base station.

FIG. 11 is a schematic view of one embodiment of the present invention.

FIG. 12 supplies a schematic illustration of transmissions propagated among a number of cells.

### A DETAILED DESCRIPTION OF PREFERRED & ALTERNATIVE EMBODIMENTS

I. Overview of the Invention

The present invention comprises methods and apparatus for improving the performance of conventional cellular telephone systems. In one embodiment, a relay transceiver is employed to receive signals from terminals in a cell, and then to send those signals to the base station located in that cell.

In this Specification and in the claims that follow, the term “conventional cellular telephone system” encompasses any system that employs a radio that communicates with a terminal located a limited region, zone or “cell.” The term “cell” pertains to a volume of space which resides generally above the surface of the Earth, and which is defined by a boundary or enclosure that is permanently associated with landmarks or some fixed geographic feature. A cell may be circular, or may be configured in some other suitable shape. In one embodiment of the invention, a the term “cell” refers to the coverage area of a base station.

An “inner cell” is generally located within a cell. A “microcell” is a relatively small cell. More than one microcell may comprise a cell. A “supercell” is a relatively large cell. More than one cell may comprise a supercell.

A “base station” includes any device for communicating over a distance, including a transmitter, receiver or transceiver that utilizes the radio, optical or other portions of the electromagnetic spectrum. In some instances, a base station may be referred to as a “base unit” or a “hub.” In one embodiment of the invention, a base station is afixed radio that is directly connected to a network, and which communicates with terminals.

A “terminal” generally refers to a handheld, mobile, fixed or other terminal which is capable of either receiving a signal from a base station, sending a signal to a base station, or both. In some cases, a terminal may be described as a “mobile station,” “mobile unit,” “subscriber unit,” or “handheld.” In general, all these terms refer to a radio that is used to communicate with the base station, and, in general, to another terminal that communicates through the network.

A “transmitter” is any device or means for sending a signal, while a “receiver” is any device or means for receiving a signal. A “transceiver” is capable of both sending and receiving.

A “network” comprises any combination, aggregation or assembly of links between nodes, terminals or some other source of signal, data or intelligence. A network may include a public switched telephone network (PSTN), the Internet, or a private network.

A “signal” encompasses any form of intelligence, language, data, content, sensation, representation or other form of communication. The terms “forward link,” “forward path,” and “forward channel” may be employed to signals that are transmitted from a base station to a terminal. The terms “reverse link,” “reverse path,” and “reverse channel” may be utilized to refer to signals that are transmitted from a terminal to a base station.

II. Preferred & Alternative Embodiments of the Invention

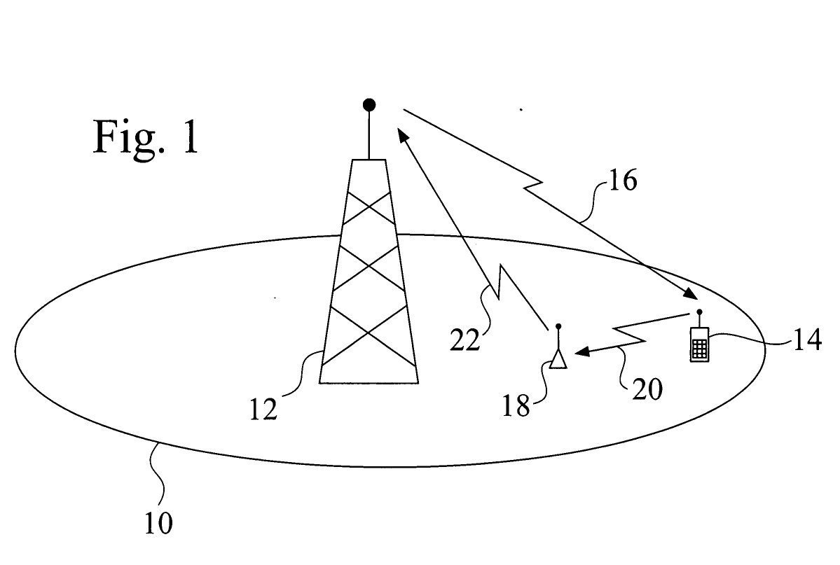

FIG. 1 is a schematic illustration of one embodiment of the invention. A cell 10 provides communication services to a region, zone or space that is generally fixed with respect to the surface of the Earth. In this embodiment, a base station 12 is located within the confines or on the periphery of the cell 10. The base station 12 includes a radio which is capable of transmitting a signal to and/or receiving a signal from a terminal 14. In FIG. 1, the terminal 14 is shown as a handheld cellular telephone. In this embodiment, a first signal 16 from the base station 12 to the terminal 14 generally conveys a voice communication from another person connected to the network which includes the base station 12. When the person using the terminal 14 speaks, the terminal 14 communicates with a relay transceiver 18 via a second signal 20. The relay transceiver 18 then emits a third signal 22 back to the base station 12, where the voice message is conveyed back to the other caller across the network. In this embodiment, the relay transceiver 18 provides point-to-point communications.

In one embodiment of the invention, millimeter waves are utilized for communications. In another embodiment of the invention, microwave frequencies are employed.

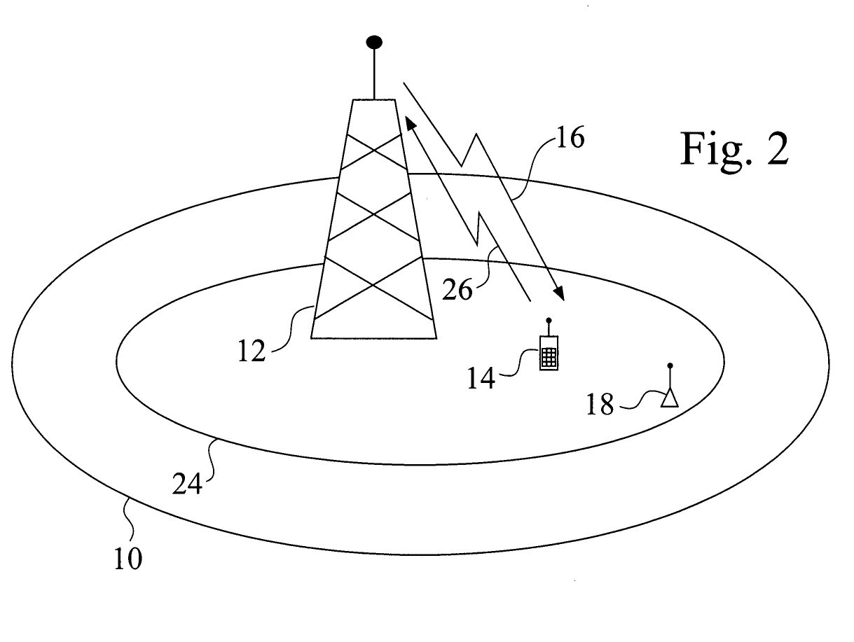

In FIG. 2, an inner cell 24 has been added within the cell 10. The inner cell 24 defines a region in which a terminal 14 communicates directly with the base station 12 in both directions without utilizing the relay transceiver 18. If a terminal 14 is within the inner cell 24, the terminal 14 communicates directly with the base station 12 using first signal 16 and a direct return signal 26.

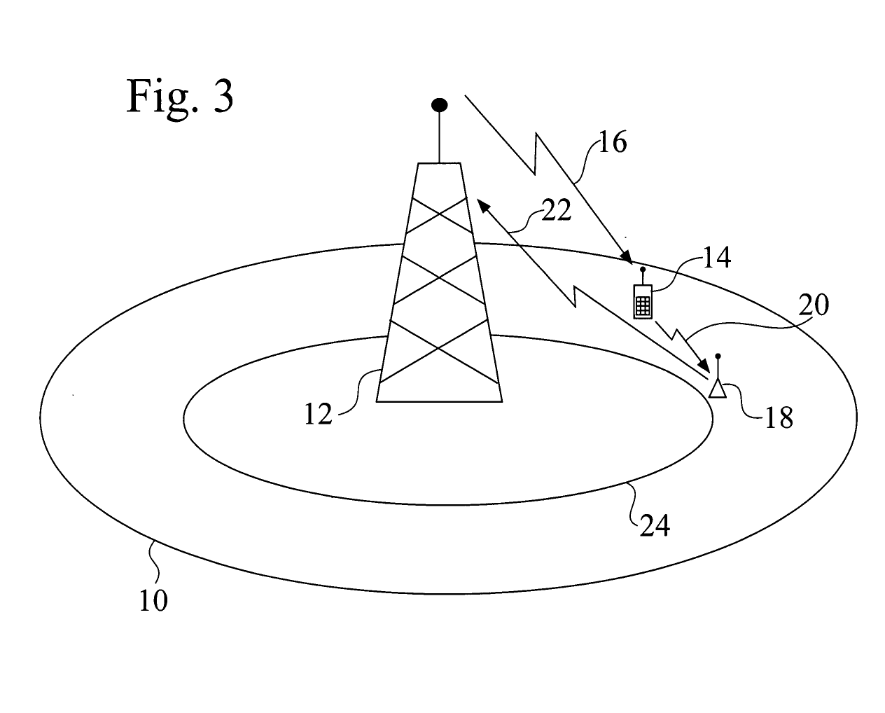

If a terminal 14 is within cell 10, but is outside inner cell 24, the return link from the terminal 14 to the base station 12 is completed with two hops, the second signal 20 from the terminal 14 to the relay transceiver 18, followed by the third signal 22 from the relay transceiver 18 to the base station 12. The signal flow that occurs when the terminal 14 is located outside the inner cell 24 is portrayed in FIG. 3.

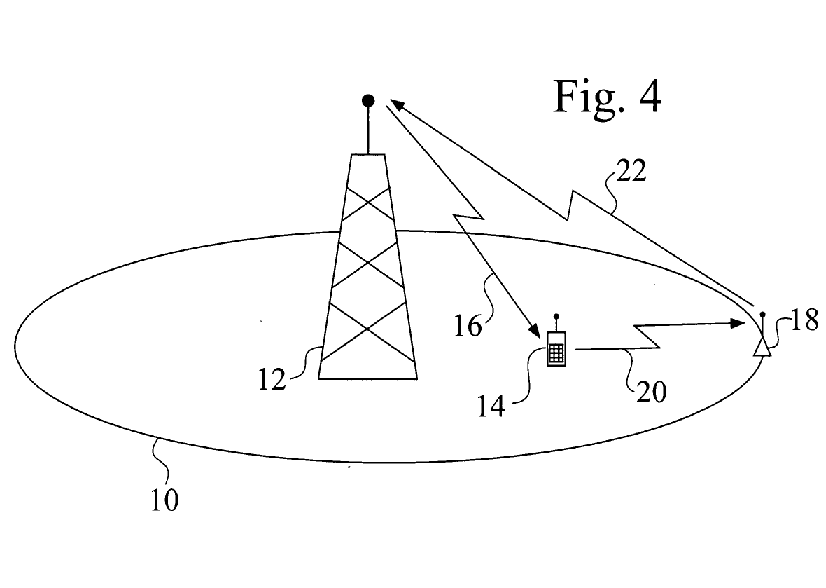

FIG. 4 provides another schematic view of the present invention, portraying a relay transceiver that is located generally at the periphery of a cell.

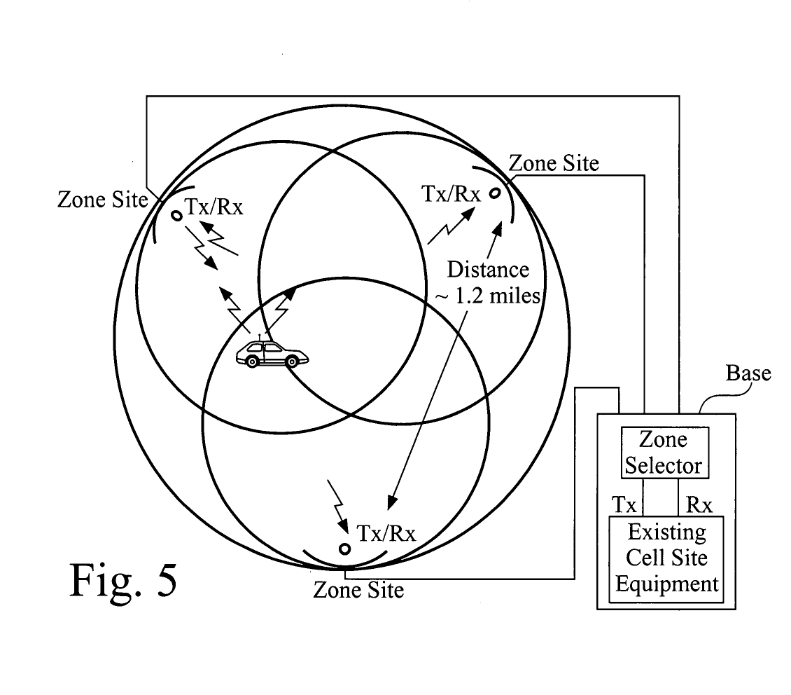

FIG. 5 supplies a view of a vehicle as it passes through a set of multiple cells.

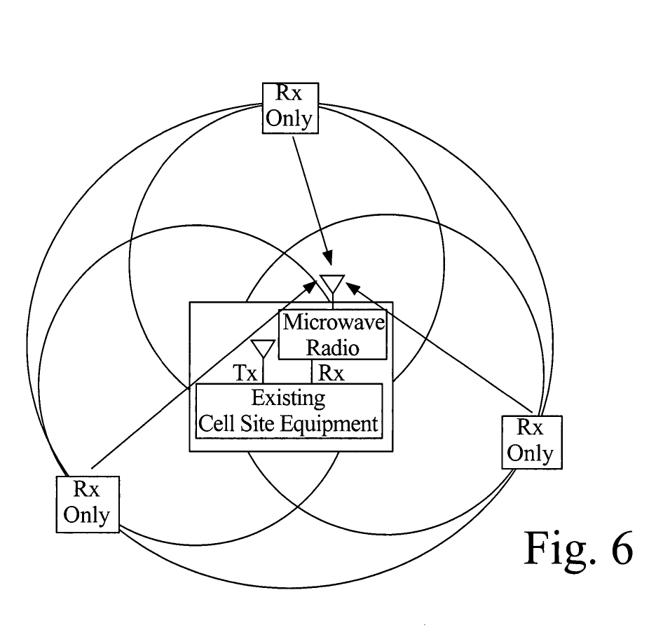

FIG. 6 provides a view of the operation of relay transceivers which are located at the periphery of a cell 10.

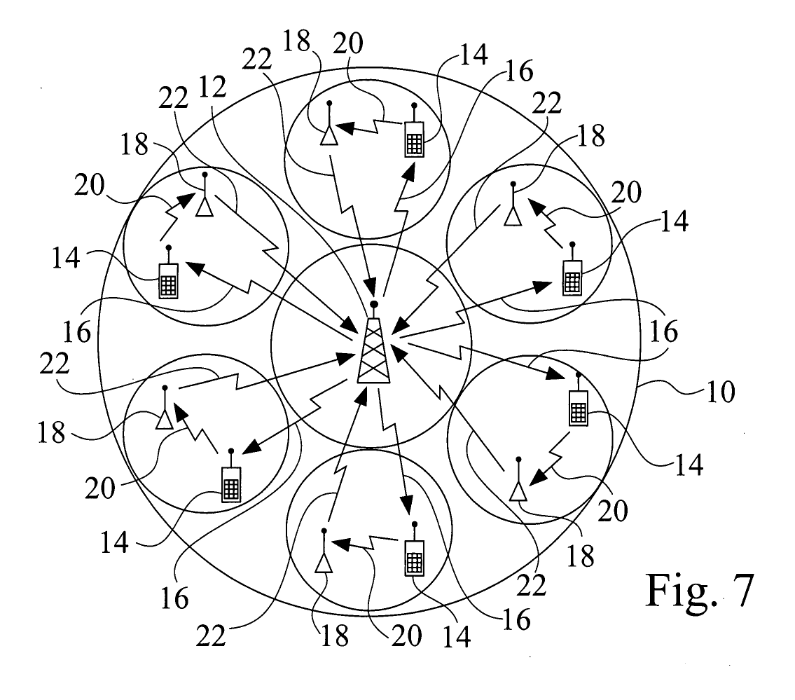

FIG. 7 offers a plan view of antenna footprints for a base station and relay transceivers.

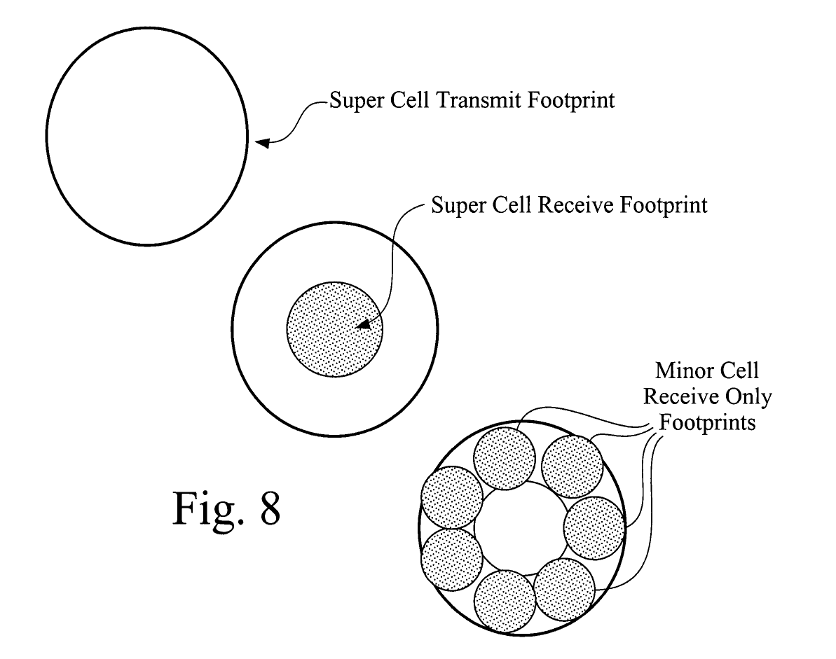

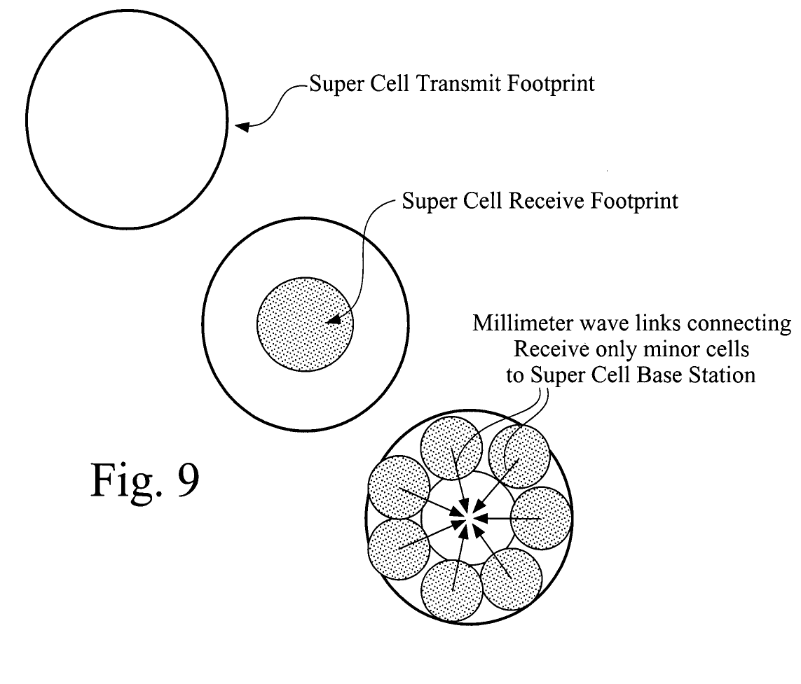

FIGS. 8 and 9 furnish schematic depictions of footprints.

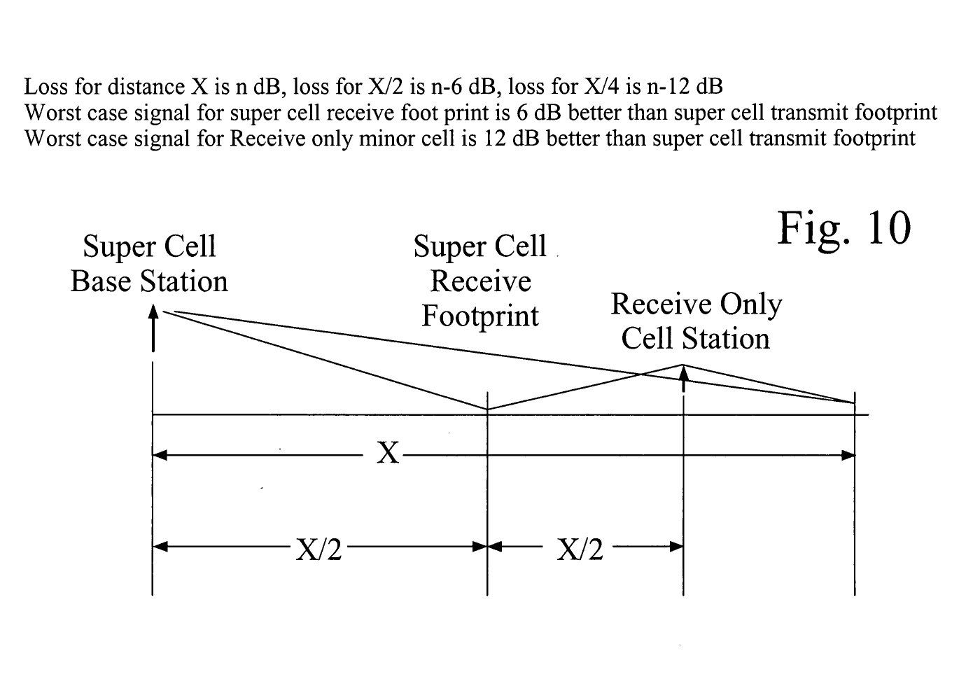

FIG. 10 depicts signal losses over distances from a base station.

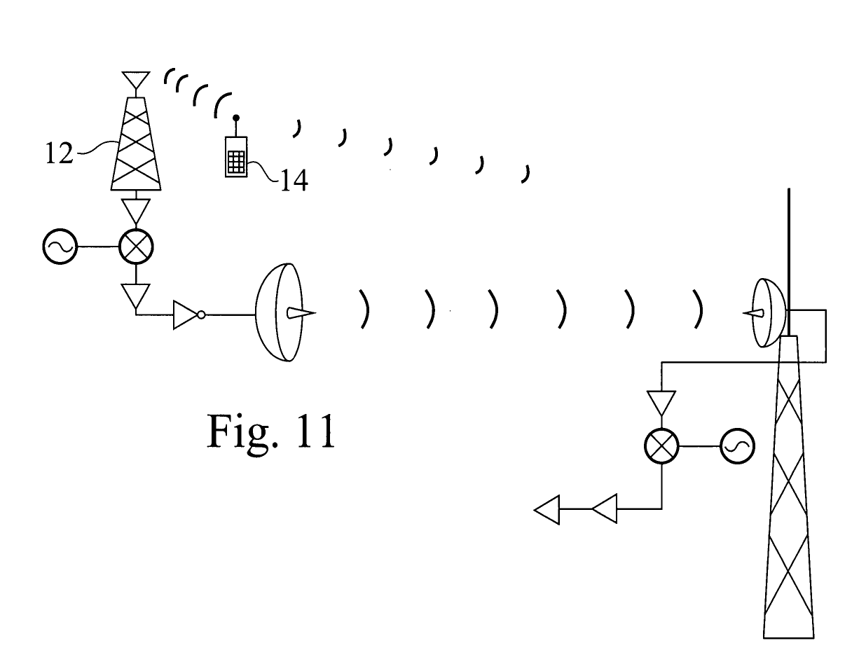

FIG. 11 is a schematic view of one embodiment of the present invention.

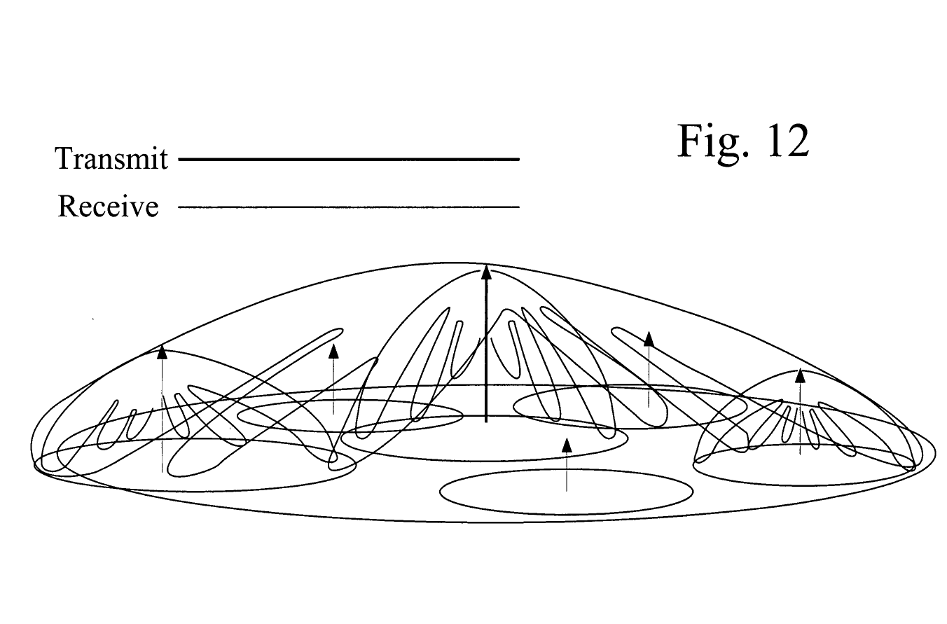

FIG. 12 supplies a schematic illustration of transmissions propagated among a number of cells.

III. A Detailed Description of a Particular Embodiment of the Invention

In one embodiment of the invention, an array of receive antennas at the edge of the cell footprint. The base station transmit pattern is adjusted to cover the entire footprint. The base station receive pattern is adjusted to cover one half the distance to the cell boundary. The receive array nodes are placed in generally equally spaced locations around the base station on a circle centered at the base station and with a radius of three fourths of the radius of the cell coverage. The antenna patterns of the receive nodes are adjusted to cover from one half the radius of the main cell to the edge of the cell.

The signals from the receive nodes are carried back to the base station using a millimeter wave link, which can incorporate upwards of 5 GHz of RF spectrum, enabling cellular and PCS systems to operate simultaneously from this system. The present invention may also be implemented using the WiFi band. Once the receive node signals are carried back to the base station, they are processed as if they were received by the main cell site receive system, allowing for a few microseconds of additional delay. The net effect is that the handheld terminal return transmit link margin increases by 4 to 10 dB in a system that used a cell that is three miles in diameter.

In one particular embodiment of the invention, an enhanced cellular communications system includes:
1. A central base station which has transmit antenna patterns optimized for operation to the edge of the cell footprint, the super cell, and receive antennas that are optimized half way to the edge of the super cell footprint. Both the transmit and receive antennas employ shaped beams to provide constant power independent of the range.
2. A series of cellular receive only antennas located generally equally spaced on a circle with a center at the central base station and a radius of three-fourths the radius of the super cell. Each of the receive only antenna locations defines a minor cell footprint.
3. A high frequency point to point interconnect for transmitting the received signals gathered at the minor cell footprint receive only cellular antennas back to a central super site.
4. A high frequency millimeter wave receiver subsystem at the super cell base station to receive the minor cell receive only signal transmitted back to the super cell base station.
5. A millimeter wave translator to convert the cellular receive only minor cell signals back to the original cellular frequency.
6. A routing system to connect the received and translated cellular signals to the base station electronics where the hand held signals can be processed as if they had been received by the base station super cell receive antennas and receivers.

Although this detailed description of one particular implementation of the invention incorporates unique design features, characteristics, geometries, and numerical specifications, this description is provided only as an illustration, and is not intended to limit the scope of the claims which follow this Specification.

IV. Advantages of the Present Invention

The present invention offers, but is not limited to, the following advantages:
Cell stations are interconnected with wideband E-Band links which transmit the entire cellular, PCS or WiFi spectrum (translated).
Only a portion of the the cell stations need to have expensive transmitters.
All cells stations have receivers.
All cell station receive signals are compared at the node (time of arrival, frequency, cell station ID).
Signal can be processed as analog linear or as a digitized representation.
Wide separation of receive sites (enabled by the E-Band bandwidth) give high performance signal deinterleaving and receive link gain.
Cell station transmitter signals can also be distributed to any other cell station locations to pick up transmit link margin.
Master cell station (which is expensive) correlates all signals and provides gain.
Master cell station can be located at the highest point in the master cell.
Master cell station can be located in a high flying aircraft orbiting over a single point.
Master cell station can be situated on a sub-orbital platform.
Master cell station can be situated on a satellite.
Fiber optic or coax cable can be used as cell station interconnect when available.
Advantage over present mimo and rake systems designs because of wide separation of receive cell stations.
Practical out to 1-5 miles cell station separation (12 microsecond to 60 microsecond time of flight delay).
Antenna gain is low cost link margin.
Transmit antenna aimed at 2 cell diameter.
Receive antenna aimed at 1 cell diameter.
High gain antenna (70 to 90 inch vertical dimension 18 to 24 dB gain at cellular—very low sidelobe to prevent cell bleed over into adjacent cell.
Receive cells have one half distance as the transmit cell, which gives 6 to 10 db receive link margin performance improvement.
Transmit cell, with 2× distance makes up with an additional power output which is easy for base station and diffiult for the hand held.
Enabling technology is the wideband backhaul provided by the E-Band radio point to point link nominal.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the claims that follow. The various alternatives for providing a Cellular Communication System that have been disclosed above are intended to educate the reader about preferred embodiments of the invention, and are not intended to constrain the limits of the invention or the scope of claims.

### LIST OF REFERENCE CHARACTERS

10 Cell
12 Base station
14 Terminal
16 First signal from base station to terminal
18 Relay transceiver
20 Second signal from terminal to relay transceiver
22 Third signal from relay transceiver to base station
24 Inner cell

What is claimed is:

1. An apparatus comprising:
a base station in a cell;
a terminal located in said cell;
said terminal for communication with said base station; said terminal receiving a first signal from said base station;
said cell including a microcell;
said terminal being located in said microcell;
said microcell including a relay transceiver for receiving a second signal from said terminal and for transmitting said second signal from said relay receiver to said base station using a relay signal.

2. An apparatus as recited in claim 1, in which said base station is generally located on the ground.

3. An apparatus as recited in claim 1, in which said base station is generally located above the ground.

4. An apparatus as recited in claim 3, in which said base station is located on a sub-orbital platform.

5. An apparatus as recited in claim 3, in which said base station is located on a satellite.

6. An apparatus as recited in claim 1, in which said base station and said terminal both operate generally within the frequency below 6 GHz.

7. An apparatus as recited in claim 1, in which said relay transceiver operates generally within the frequency band above 3.5 GHz.

8. An apparatus as recited in claim 1 further comprising:
an inner cell; said base station being located generally in said inner cell; and
said terminal communicating directly with said base station when said terminal is located in said inner cell.

9. An apparatus as recited in claim 8, in which said base station is located generally in the center of said inner cell.

10. An apparatus as recited in claim 8, in which said base station is located generally on the edge of said inner cell.

11. An apparatus as recited in claim 8, in which said base station uses a shaped beam to define the shape of said inner cell.

12. An apparatus as recited in claim 1, in which said cell is generally circular.

13. An apparatus as recited in claim 8, in which said inner cell is generally circular.

14. An apparatus as recited in claim 1, in which said cell is a member of a group of cells in a honeycomb pattern.

15. An apparatus as recited in claim 1, in which said microcell is generally circular.

16. An apparatus as recited in claim 1, in which said cell is formed in a non-circular to optimize performance.

17. An apparatus as recited in claim 1, in which said microcell is formed in a non-circular to optimize performance.

18. An apparatus as recited in claim 1, in which said relay transceiver 18 provides point-to-point communications.

19. An apparatus as recited in claim 1, in which said relay transceiver 18 is generally located at the periphery of a cell.

20. An apparatus as recited in claim 1, in which millimeter waves are utilized for communications.

21. An apparatus as recited in claim 1, in which microwave frequencies are utilized for communications.

22. A method comprising the steps of:
transmitting a first signal from a base station;
receiving said first signal from said base station using a terminal;
transmitting a second signal from said terminal to a relay transceiver; and
relaying said second signal from said relay transceiver to said base station.

23. A propagated signal comprising:
a first signal transmitted from a base station;
said first signal from said base station being received by a terminal;
a second signal transmitted from said terminal to a relay transceiver; and
a third signal transmitted from said relay transceiver back to said base station.
